(19) United States
(12) Patent Application Publication
(10) Pub. No.: US 2017/0255288 A1
(43) Pub. Date: Sep. 7, 2017

(54) TOUCH DISPLAY PANEL AND TOUCH DISPLAY DEVICE

(71) Applicants: BOE Technology Group Co., Ltd., Beijing (CN); Beijing BOE Optoelectronics Technology Co., Ltd., Beijing (CN)

(72) Inventors: Lei Wang, Beijing (CN); Rui Xu, Beijing (CN); Xiaochuan Chen, Beijing (CN); Ming Yang, Beijing (CN); Pengcheng Lu, Beijing (CN); Wenqing Zhao, Beijing (CN); Qian Wang, Beijing (CN); Xiaochen Niu, Beijing (CN); Jian Gao, Beijing (CN)

(21) Appl. No.: 15/207,715

(22) Filed: Jul. 12, 2016

(30) Foreign Application Priority Data
Mar. 3, 2016 (CN) 201610121974.4

(51) Int. Cl. G06F 3/041

(52) U.S. Cl. CPC G06F 3/041; G06F 2203/04103

(57) ABSTRACT

The present disclosure provides a touch display panel and a touch display device, for simplifying the structure of the touch display panel and reducing the cost of the touch display panel. The touch display panel includes an array substrate and an opposite substrate assembled together to form a cell, a sealant located within the edge frame area between the array substrate and the opposite substrate and containing therein a conductive gold ball, a sensing electrode located on a side of the opposite substrate facing away from the array substrate, and a touch drive integrated circuit located on the array substrate. The opposite substrate is provided with, within the edge frame area, a first via hole penetrating the opposite substrate and filled therein with a first conductor, and the sensing electrode is electrically connected with the touch drive integrated circuit via the first conductor and the conductive gold ball.

### CROSS-REFERENCE TO RELATED APPLICATION

This application claims the benefit of the Chinese Patent Application No. 201610121974.4 filed on Mar. 3, 2016 in the State Intellectual Property Office of China, the whole disclosure of which is incorporated herein by reference.

### BACKGROUND OF THE INVENTION

Field of the Invention

Embodiments of the present disclosure generally relate to the field of display technologies, and particularly, to a touch display panel and a touch display device.

Description of the Related Art

With development of science and technology, a touch display panel has been gradually developed, and an Add-On structural design is generally applied in mainstream products. For a touch screen with a conventional Add-on structure, however, the display panel, as a whole, has a rather large thickness and weight and a high cost. With thinning requirement of a customer on the display panel, an In-Cell type liquid crystal screen becomes an important growing trend in the touch field.

For example, as shown in FIG. 1, a display panel with a HIC (Hybrid Integrated Circuit) structure comprises an array substrate 11 and an opposite substrate 12 assembled together to form a cell, a sensing electrode 13 located on a side of the opposite substrate 12 facing away from the array substrate 11, a touch electrode 15 located on the array substrate 11, a first printed circuit board (FPC1) 14 located on the opposite substrate 12 and electrically connected with the sensing electrode 13, and a second printed circuit board (FPC2) 16 located on the array substrate 12 and electrically connected with the touch electrode 15. As can be seen, since the sensing electrode is formed on a side of the opposite substrate, it is required to separately manufacture the first printed circuit board 14 on the opposite substrate, the first printed circuit board 14 is configured to receive a sensing signal from the sensing electrode and is connected to the second printed circuit board through an interface (not shown) for signal loading. Thus, this type display panel has a more complex structure, requiring additional interfaces and the like, and has a raised cost due to designs associated with the additional interfaces. Also, for a SLOC (single-layer-on-cell) type display panel, as a touch electrode and a sensing electrode are both arranged on a side of the opposite substrate facing away from the array substrate, it is also required to provide a first printed circuit board on the opposite substrate for providing signals for the touch electrode and the sensing electrode, then the first printed circuit board is connected to a second printed circuit board through an interface.

In sum, the prior art touch display panel is provided with a printed circuit board on the opposite substrate, which increases structural complexity and cost of the touch display panel.

### SUMMARY

Embodiments of the present disclosure provides a touch display panel and a touch display device, for simplifying the structure of the touch display panel and for reducing cost of the touch display panel.

According to an aspect of the present disclosure, there is provided a touch display panel, the touch display panel having a display area and an edge frame area around the display area and comprising: an array substrate and an opposite substrate, which are assembled together to form a cell; a sensing electrode located on a side of the opposite substrate facing away from the array substrate; a first conductive structure provided within the edge frame area; and a touch drive integrated circuit located on the array substrate, wherein the sensing electrode is electrically connected with the touch drive integrated circuit via the first conductive structure.

In an embodiment, the touch display panel further comprises a sealant located within the edge frame area and between the array substrate and the opposite substrate and containing therein a conductive gold ball, wherein the opposite substrate is provided with a first via hole within the edge frame area, the first via hole penetrates the opposite substrate and is filled therein with a first conductor that is electrically connected with a corresponding conductive gold ball in the sealant, and the first conductive structure is comprised of the first conductor and the conductive gold ball. In an embodiment, each sensing electrode corresponds to at least one first via hole.

In an embodiment, each first via hole is provided within a portion of the edge frame area corresponding to the sealant such that the first conductor filled in the first via hole is in direct electrical contact with the corresponding conductive gold ball in the sealant.

In an embodiment, each first via hole has a circular cross-section with a diameter smaller than or equal to the width of the corresponding sensing electrode.

In an embodiment, the touch display panel further comprises a first signal line arranged on the array substrate and electrically connected with the conductive gold ball corresponding to the first via hole and the touch drive integrated circuit.

In an embodiment, there is a one-to-one correspondence between the first signal line and the sensing electrode.

In an embodiment, the touch display panel further comprises a touch electrode arranged on the array substrate, the touch electrode being provided in a one-to-one correspondence with the sensing electrode.

In an embodiment, the touch display panel further comprises a touch electrode arranged on the opposite substrate and a second conductive structure provided within the edge frame area, the touch electrode being electrically connected with the touch drive integrated circuit via the second conductive structure.

In an embodiment, the opposite substrate is provided with a second via hole within the edge frame area, the second via hole penetrates the opposite substrate and is filled therein with a second conductor that is electrically connected with a corresponding conductive gold ball in the sealant, and the second conductive structure is comprised of the second conductor and the conductive gold ball corresponding to the second conductor.

In an embodiment, each sensing electrode corresponds to at least one second via hole.

In an embodiment, the second via hole is provided in a portion of the opposite substrate within the edge frame area and corresponding to the sealant, such that the second conductor filled in each first via hole is in direct electrical contact with the corresponding conductive gold ball in the sealant.

In an embodiment, each second via hole has a circular cross-section with a diameter smaller than or equal to the width of the corresponding touch electrode.

In an embodiment, the touch display panel further comprises a second signal line arranged on the array substrate, the first signal line being electrically connected with the touch drive integrated circuit and the conductive gold ball that corresponds to the second via hole.

In an embodiment, there is a one-to-one correspondence between the second signal line and the touch electrode.

According to another aspect of the present disclosure, there is provided a touch display device, comprising the touch display panel according to embodiments of the present disclosure as described above.

The touch display panel according to embodiments of the present disclosure has a display area and an edge frame area around the display area and comprises an array substrate and opposite substrate that are assembled together to form a cell, a sensing electrode located on a side of the opposite substrate facing away from the array substrate, a first conductive structure provided within the edge frame area, and a touch drive integrated circuit located on the array substrate and electrically connected with the sensing electrode through the first conductive structure. For example, the touch display panel may further comprise a sealant located within the edge frame area between the array substrate and the opposite substrate and containing therein a conductive gold ball, the opposite substrate is provided with a first via hole within the edge frame area, the first via hole extends through the opposite substrate and is filled therein with a first conductor electrically connected with corresponding conductive gold ball in the sealant, and the first conductive structure is comprised of the first conductor and the conductive gold ball. Thus, the conductive structure is provided within the edge frame area of the display panel, and for example, the first via hole is provided in the opposite substrate, such that the sensing electrode on the opposite substrate is electrically connected with the touch drive integrated circuit on the array substrate through the conductive structure (for example, comprising the first conductor filled in the first via hole and the conductive gold ball(s) in the sealant), thereby there is no need to provide any printed circuit board on the opposite substrate for signal communication with the sensing electrode, enabling a simple structure of the touch display panel and a reduction in cost of the touch display panel.

### BRIEF DESCRIPTION OF THE DRAWINGS

FIG. 1 is a structural schematic diagram of a touch display panel in prior arts;

FIG. 2 is schematic plan view of a touch display panel according to an embodiment of the present disclosure;

FIG. 3 is a schematic sectional view taken along a-a1 direction shown in FIG. 2;

FIG. 4 is a schematic sectional view taken along b-b1 direction shown in FIG. 2;

FIG. 5 is another schematic sectional view according to an embodiment of the present disclosure, taken along b-b1 direction shown in FIG. 2;

FIG. 6 is a schematic plan view of an opposite substrate of a first touch display panel according to an embodiment of the present disclosure;

FIG. 7 is a schematic sectional view of a second touch display panel according to an embodiment of the present disclosure, taken along the a-a1 direction shown in FIG. 2;

FIG. 8 is a schematic sectional view of a third touch display panel according to an embodiment of the present disclosure, taken along the a-a1 direction shown in FIG. 2;

FIG. 9 is a schematic sectional view of the second touch display panel according to an embodiment of the present disclosure, taken along the b-b1 direction shown in FIG. 2;

FIG. 10 is a schematic sectional view of a fourth touch display panel according to an embodiment of the present disclosure, taken along the a-a1 direction shown in FIG. 2;

FIG. 11 is a schematic sectional view of the third touch display panel according to an embodiment of the present disclosure, taken along the b-b1 direction shown in FIG. 2;

FIG. 12 is a schematic plan view of an opposite substrate of the second touch display panel according to an embodiment of the present disclosure; and

FIG. 13 is a schematic sectional view of a fifth touch display panel according to an embodiment of the present disclosure, taken along the a-a1 direction shown in FIG. 2.

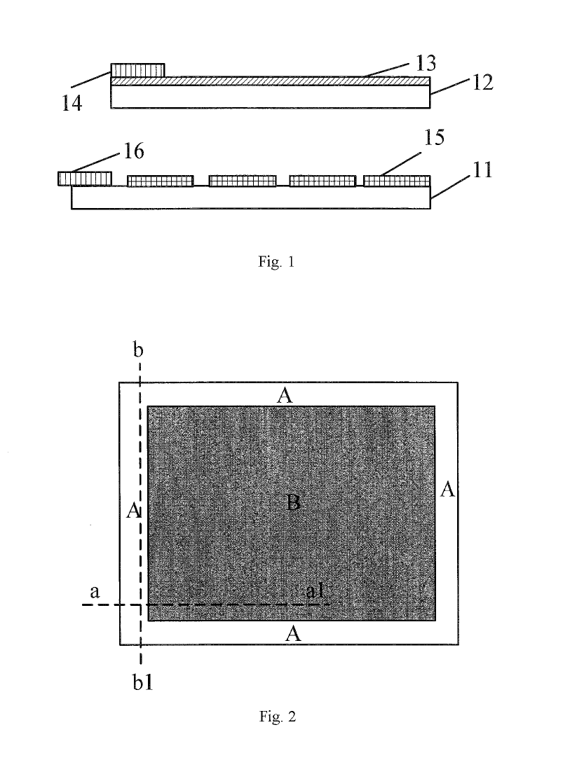

### DETAINED DESCRIPTION OF PREFERRED EMBODIMENTS OF THE INVENTION

In order to make clearer understanding of the above objects, features and advantages of the present disclosure, the present invention will be described hereinafter in detail with reference to exemplary embodiments and accompanying drawings. It is noted that in case of no conflict, the embodiments and features thereof of the present disclosure may be randomly combined.

In the following detailed description, for purposes of explanation, numerous specific details are set forth in order to provide a thorough understanding of the disclosed embodiments. It will be apparent, however, the present invention may be embodied in many different forms and should not be construed as being limited to the embodiments set forth herein; rather, these embodiments are provided so that the present invention will be thorough and complete, and will fully convey the concept of the disclosure to those skilled in the art.

Embodiments of the present disclosure provides a touch display panel and a touch display device, for simplifying the structure of the touch display panel and for reducing cost of the touch display panel.

The touch display panel and the touch display device provided according to exemplary embodiments of the present disclosure will be described in detail hereinafter.

FIG. 2 is schematic plan view of a touch display panel according to an embodiment of the present disclosure, and FIG. 3 is a schematic sectional view taken along a-a1 direction shown in FIG. 2. With reference to FIG. 2, the touch display panel has a display area B and an edge frame area A (i.e., non-display area). With reference to FIG. 3, the touch display panel according to an embodiment of the present disclosure comprises an array substrate 11 and an opposite substrate 12 assembled together to form a cell, a sealant 21 located within the edge frame area A between the array substrate 11 and the opposite substrate 12 and containing therein conductive gold ball(s) 22, a sensing electrode 13 located on a side of the opposite substrate 12 facing away from the array substrate 11, and a touch drive integrated circuit 23 located on the array substrate 11. The opposite substrate 12 is provided with, within the edge frame area A, a first via hole 24 extending through or penetrating the opposite substrate and filled therein with a first conductor 25, and the sensing electrode 13 is electrically connected with the touch drive integrated circuit 23 via the first conductor 25 and the conductive gold ball 22.

It is noted that in order to avoid adverse influence on an aperture ratio and a normal display function of the touch display panel, according to embodiments of the present disclosure, the first via hole is located within the edge frame area of the touch display panel, particularly within a portion of the edge frame area between the array substrate and the opposite substrate that corresponds to the sealant. The sealant contains therein conductive gold ball(s), such that the sensing electrode is electrically connected with the array substrate via the first conductor 25 and the conductive gold ball.

The touch display panel according to the embodiment of the present disclosure comprises an array substrate and an opposite substrate assembled together to form a cell, a sealant located within the edge frame area between the array substrate and the opposite substrate and containing therein conductive gold ball(s), a sensing electrode located on a side of the opposite substrate facing away from the array substrate, and a touch drive integrated circuit located on the array substrate. The opposite substrate is provided with, within the edge frame area, a first via hole extending through or penetrating the opposite substrate and filled therein with a first conductor, and the sensing electrode is electrically connected with the touch drive integrated circuit via the first conductor and the conductive gold ball. Thus, as a result of providing the first via hole in the opposite substrate such that the sensing electrode on the opposite substrate is electrically connected with the touch drive integrated circuit on the array substrate via the conductive structure (for example, comprising the first conductor filled in the first via hole and the conductive gold ball(s) in the sealant), there is no need to provide any printed circuit board on the opposite substrate for signal communication with the sensing electrode, thereby simplifying structure of the touch display panel and reducing cost of the same.

In an example of the above touch display panel according to an embodiment of the present disclosure, one sensing electrode corresponds to at least one first via hole.

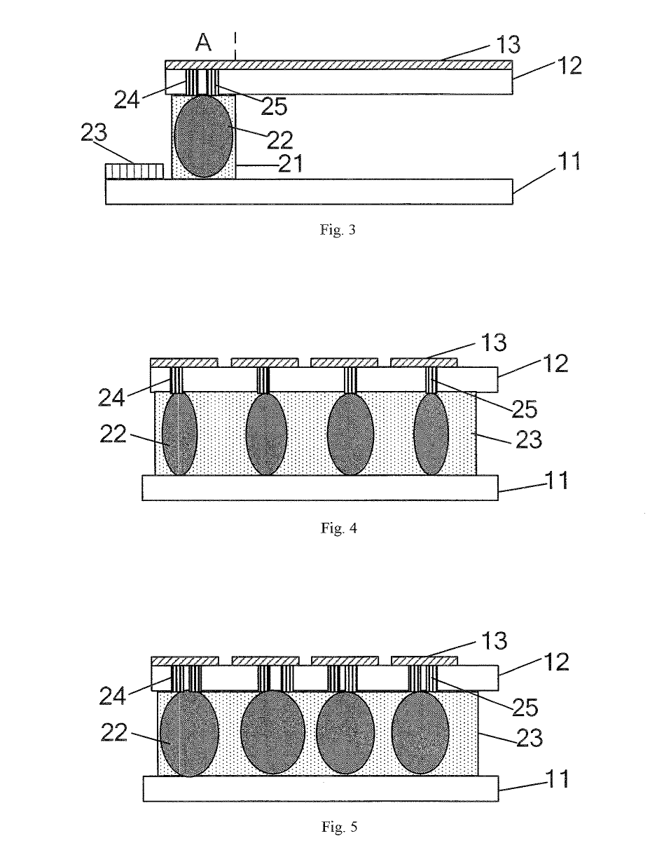

Exemplarily, with reference to FIG. 4, which is a schematic sectional view of the touch display panel shown in FIG. 2 taken along b-b1 direction, the opposite substrate 12 is provided thereon with a plurality of the sensing electrodes 13, each being electrically connected with the conductive gold ball 22 in the sealant via the first conductor 25 in the first via hole 24. In an example, each of the plurality of the sensing electrodes 13 corresponds to one first via hole 24. In an embodiment according to the present disclosure, in order to provide a better electrical connection of the sensing electrode with the touch drive integrated circuit through the conductive gold ball, a plurality of first via holes may be provided, in the opposite substrate, within a portion of the edge frame area corresponding to each of the plurality of sensing electrodes. For example, with reference to FIG. 5, each of the sensing electrodes 13 corresponds to two first via holes 24, such that the sensing electrode may be electrically connected with the touch drive integrated circuit in a better manner. Further, in the embodiment where each of the sensing electrodes corresponds to two or more first via holes, resistance between the sensing electrode and the touch drive integrated circuit may be reduced, thereby improving efficiency of transmitting sensing signals.

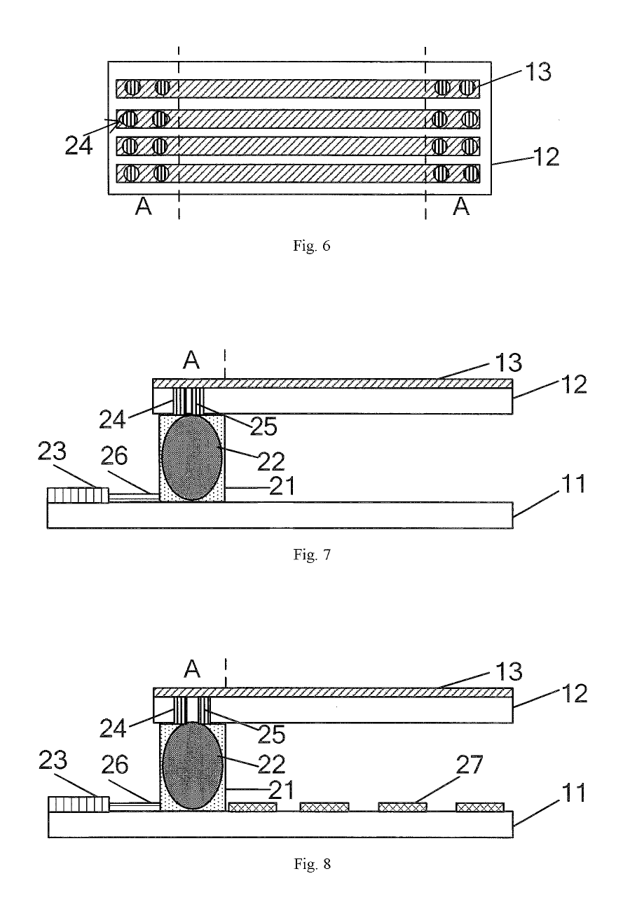

In one embodiment according to the present disclosure, the opposite substrate is provided thereon with a plurality of sensing electrodes, which are arranged in the same extending direction and each correspond to at least one first via hole. Thus, a plurality of the first via holes may be arranged in an array in the opposite substrate within the edge frame area. Exemplarily, with reference to FIG. 6, which is another plan view of a touch display panel according to an embodiment of the present disclosure, the opposite substrate 12 is provided thereon with a plurality of the sensing electrodes 13 extending in a right and left direction, and the first via hole 24 is provided, in the opposite substrate, within a portion of the edge frame area A corresponding to each of the sensing electrodes. In an example, each of the sensing electrodes 13 corresponds to two the first via holes 24. The plurality of the first via holes are arranged in an array. In one example, each of the first via holes 24 has a circular cross-section with a diameter equal to the width of the corresponding sensing electrode.

It is noted that, FIG. 6 is only provided for describing an example in detail where each of the sensing electrodes corresponds to two first via holes and the first via hole has a circular cross-section. Of course, each of the sensing electrodes may correspond to three or more first via holes, and the cross-section of the first via hole may be square, triangular or other shapes; when the first via hole has a circular cross-section, the diameter of the first via hole may be set by a value smaller than the width of the sensing electrode, or other value. Number, shape and size of the first via hole may be set as required, and are not particularly limited in embodiments of the present disclosure.

In one example of the above touch display panel according to embodiments of the present disclosure, with reference to FIG. 7, the array substrate 11 is further provided thereon with a first signal line 26, which is electrically connected with the conductive gold ball 22, corresponding to the first via hole 24, and the touch drive integrated circuit 23.

Illustratively, the touch drive integrated circuit is located on a side of the array substrate, and is in signal communication with the sensing electrode via the first signal line, the conductive gold ball and the first conductor as described above. For example, the touch drive integrated circuit is configured to receive a sensing signal from the sensing electrode or to transmit other signal to the sensing electrode.

It is noted that, in order to avoid an additional process and increase in thickness of the array substrate when manufacturing the first signal line, the first signal line may be formed in the same layer as a data line on the array substrate and is electrically insulated from the data line, or formed in the same layer as a gate line and is electrically insulated from the gate line; or, a new layer of the first signal line is added on the array substrate while reducing thicknesses of other layers on the array substrate.

In one example of the above touch display panel according to embodiments of the present disclosure, there is a one-to-one correspondence between the first signal line and the sensing electrode.

It is noted that, in the illustrated embodiments, the sensing electrodes are located on the opposite substrate, while the first signal line is located on the array substrate; for the display panel having the structure shown in FIG. 6, FIG. 7 only illustrates a schematic sectional view of one signal line. Exemplarily, each of the sensing electrodes corresponds to one first signal line, for signal transmission therebetween.

In one example of the above touch display panel according to embodiments of the present disclosure, with reference to FIG. 8, which is a schematic sectional view of the touch display panel shown in FIG. 2 taken along the a-a1 direction, the array substrate 11 is further provided thereon with touch electrodes 27 which are arranged in a one-to-one correspondence to the sensing electrodes 27. In an example, orthogonal projections of the touch electrode 27 and the sensing electrode 13 on the array substrate 11 are perpendicular to each other.

Exemplarily, the array substrate is further provided thereon with touch electrodes which are arranged in a one-to-one correspondence to the sensing electrodes on the opposite substrate, and the touch electrodes and the sensing electrodes are driven by touch drive integrated circuit to achieve a touch function.

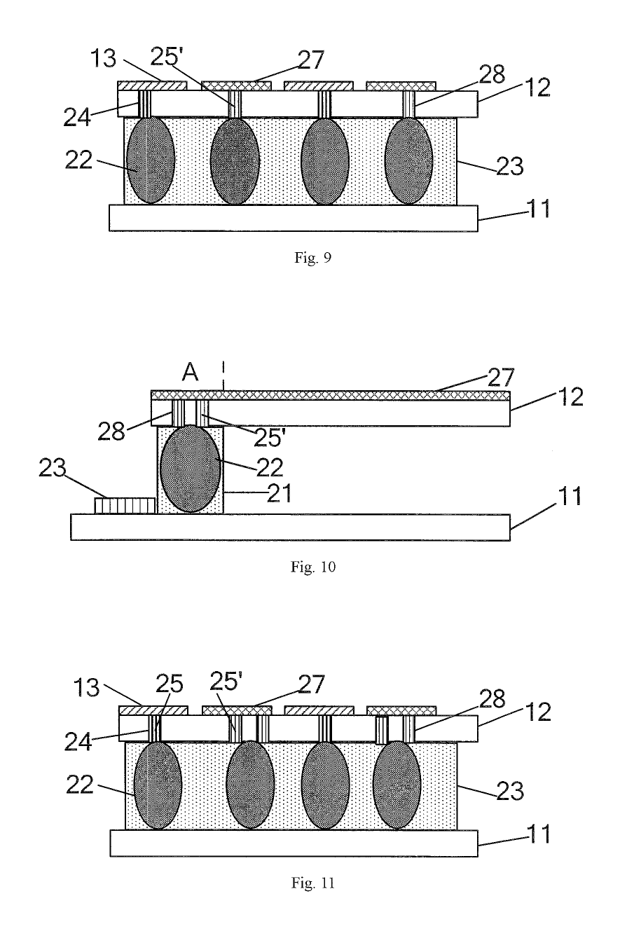

FIG. 9 is a schematic sectional view of the touch display panel shown in FIG. 2 taken along the b-b1 direction, and FIG. 10 is a schematic sectional view of the touch display panel shown in FIG. 2 taken along the a-a1 direction. In one example of the above touch display panel according to embodiments of the present disclosure, with reference to FIG. 9, the opposite substrate 12 is further provided thereon with a touch electrode 27, and is provided therein with a second via hole 28 within the edge frame area A, the second via hole 28 penetrating the opposite substrate and being filled therein with a second conductor 25′. With reference to FIG. 10, the touch electrode 27 is electrically connected with the touch drive integrated circuit 23 via the second conductor 25′ and the conductive gold ball 22 in the sealant.

It is noted that, in order to avoid adverse influence on an aperture ratio and a normal display function of the touch display panel, the second via hole according to embodiments of the present disclosure is located within the edge frame area of the touch display panel, particularly within a portion of the edge frame area of the touch display panel corresponding to the sealant, between the array substrate and the opposite substrate and. The sealant contains therein conductive gold ball(s), such that the touch electrode is electrically connected with the array substrate via the second conductor and the conductive gold ball.

In one example of the above touch display panel according to embodiments of the present disclosure, each of the sensing electrodes corresponds to at least one the second via hole.

Exemplarily, with reference to FIG. 11, the opposite substrate 12 is provided thereon with a plurality of touch electrodes 27, each being electrically connected with the conductive gold ball 22 in the sealant through the second conductor 25′ in the second via hole 28. In an example, each of the plurality of touch electrodes 27 corresponds to one the second via hole 28. In an embodiment according to the present disclosure, in order to provide a better electrical connection of the touch electrodes 27 with the touch drive integrated circuit through the conductive gold ball, a plurality of second via holes may be provided in the opposite substrate within a portion of the edge frame area corresponding to each of the touch electrodes. For example, with reference to FIG. 11, each of the touch electrodes 27 corresponds to two the second via holes 28, such that the touch electrode may be electrically connected with the touch drive integrated circuit in a better manner. Further, as each touch electrode correspond to two or more second via holes, resistance between the touch electrode and the touch drive integrated circuit may be reduced, thereby improving efficiency of transmitting touch signals.

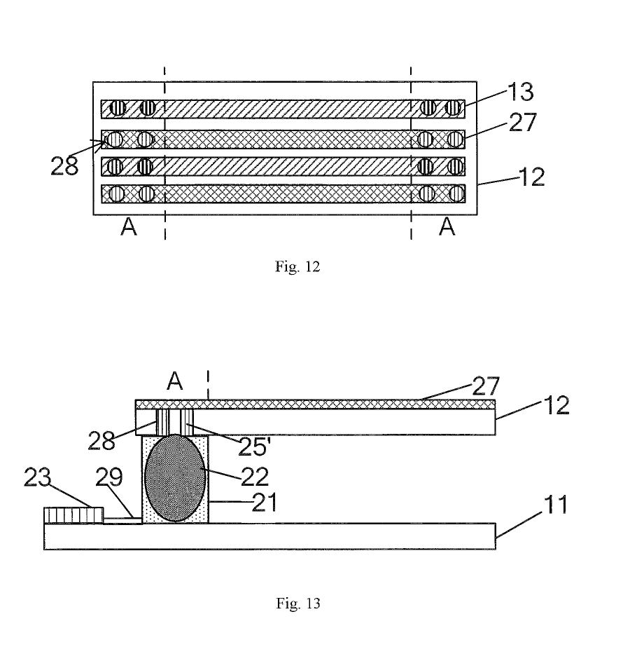

In an exemplary embodiment according to the present disclosure, the opposite substrate is provided thereon with a plurality of touch electrodes which are arranged in the same extending direction and each correspond to at least one the second via hole. Thus, a plurality of the second via holes may be arranged in an array, in the opposite substrate, within the edge frame area. Exemplarily, with reference to FIG. 12, the opposite substrate 12 is provided thereon with a plurality of the touch electrodes 27 extending in a right and left direction, and a plurality of the second via holes 28 are provided, in the opposite substrate, within a portion of the edge frame area A corresponding to each of the touch electrodes 27. In an example, each of the touch electrodes 27 corresponds to two second via holes 28. The plurality of the second via holes are arranged in an array. In one example, each of the second via holes has a circular cross-section with a diameter equal to the width of the corresponding touch electrode.

It is noted that, FIG. 12 is only provided for describing in detail an example, in which each of the touch electrodes corresponds to two the second via holes and the second via hole has a circular cross-section. Of course, each of the touch electrodes may correspond to three or more the second via holes, and the cross-section of the second via hole may be square, triangular or others shape; when the second via hole has a circular cross-section, the diameter of the second via hole may be set by a value smaller than the width of the touch electrode, or other value. Number, shape and size of the second via hole may be set as required, and are not particularly limited in embodiments of the present disclosure.

In one example of the above touch display panel according to embodiments of the present disclosure, with reference to FIG. 13, the array substrate 11 is further provided thereon with a second signal line 29, which is electrically connected with the conductive gold ball 22, corresponding to the second via hole 28, and the touch drive integrated circuit 23.

Illustratively, the touch drive integrated circuit is located on a side of the array substrate, and is configured to transmit a touch signal to the touch electrode. Specifically, the touch drive integrated circuit is configured to transmit a touch signal to the conductive gold ball through the second signal line and further to the touch electrode via the second conductor.

It is noted that, in order to avoid an additional process and increase in thickness of the array substrate when manufacturing the second signal line, the second signal line may be formed in the same layer as a data line on the array substrate and is electrically insulated from the data line, or formed in the same layer as a gate line and is electrically insulated from the gate line; or, a new layer of the second signal line is added on the array substrate while reducing thicknesses of other layers on the array substrate.

In one example of the above touch display panel according to embodiments of the present disclosure, there is a one-to-one correspondence between the second signal line and the touch electrode.

It is noted that when both the sensing electrode and touch electrode are located on the opposite substrate and both the first signal line and the second signal line are located on the array substrate, exemplarily, each of the sensing electrodes corresponds to one the first signal line, for transmission of an electrical signal to/from the sensing electrode, and each of the touch electrodes corresponds to one the second signal line, for transmission of an electrical signal to/from the touch electrode.

In an embodiment according to the present disclosure, the conductor(s) may be made of any material having an electrically conductive property, which is not particularly limited in the present disclosure.

As described above, for the HIC structure, where the sensing electrode is located on the opposite substrate while the touch electrode is located on the array substrate, embodiments of the present disclosure are made, such that a plurality of the first via holes are provided, within the edge frame area of the display panel, in a region of the opposite substrate corresponding to the sealant and are filled therein with the first conductors, and each correspond to the sensing electrode, so that each of the sensing electrodes is electrically connected with the touch drive integrated circuit located on the array substrate via the first conductor filled in the first via hole, the conductive gold ball in the sealant and the first signal line on the array substrate, which are corresponding to the sensing electrode. The touch drive integrated circuit is in communication with the sensing electrodes, for example, is configured to receive a sensing signal from the sensing electrodes or to transmit other signal to the sensing electrodes. Thus, in the touch display panel with the HIC structure according to embodiments of the present disclosure, there is no need to provide any printed circuit board on the opposite substrate, which simplifies the structure of the touch display panel and reduces cost of the touch display panel.

Correspondingly, for the SLOC structure, where both the sensing electrode and the touch electrode are located on the opposite substrate, in order to avoid providing any printed circuit board on the opposite substrate, embodiments of the present disclosure are made, such that the first via hole is provided, within the edge frame area of the display panel, in a region of the opposite substrate, which corresponds to the sensing electrode and is covered by the sealant, and are filled therein with the first conductor, and the second via hole is provided, within the edge frame area of the display panel, in a region of the opposite substrate, which corresponds to the touch electrode and is covered by the sealant, and filled therein with a second conductor. The sensing electrode is electrically connected with the touch drive integrated circuit via the first conductor filled in the first via hole, the conductive gold ball in the sealant and the first signal line, while the touch electrode is electrically connected with the touch drive integrated circuit via the second conductor filled in the second via hole, the conductive gold ball in the sealant and the second signal line, thereby achieving touch function of the touch display panel.

Further, an embodiment according to the present disclosure provides a touch display device, comprising the touch display panel according to the above embodiments of the present disclosure. The touch display device operates based on the principle for solving the problem that is similar to that of the touch display panel, and thus may be implemented with reference to the embodiments of the touch display panel as described above, which will not be repeatedly described.

To summarize, the embodiments of the present disclosure provides a touch display panel and a touch display device. The touch display panel has a display area and an edge frame area around the display area and comprises an array substrate and an opposite substrate, which are assembled together to form a cell, a sensing electrode located on a side of the opposite substrate facing away from the array substrate, a first conductive structure provided within the edge frame area, and a touch drive integrated circuit located on the array substrate and electrically connected with the sensing electrode through the first conductive structure. For example, the touch display panel may further comprise a sealant located, within the edge frame area, between the array substrate and the opposite substrate and containing therein conductive gold ball(s), wherein the opposite substrate is provided with a first via hole within the edge frame area, the first via hole penetrates the opposite substrate and is filled therein with a first conductor electrically connected with corresponding conductive gold ball in the sealant. The first conductive structure is comprised of the first conductor and the conductive gold ball(s). Thus, by providing the conductive structure within the edge frame area of the display panel, and for example, providing the first via hole in the opposite substrate, such that the sensing electrode on the opposite substrate is electrically connected with the touch drive integrated circuit on the array substrate through the conductive structure (for example, comprising the first conductor filled in the first via hole and the conductive gold ball(s) in the sealant), the touch display panel and the touch display device according to the embodiments of the present invention need no printed circuit board on the opposite substrate for signal communication with the sensing electrode, and have a simple structure and a reduced cost.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A touch display panel, the touch display panel having a display area and an edge frame area around the display area and comprising:
an array substrate and an opposite substrate, which are assembled together to form a cell;
a sensing electrode located on a side of the opposite substrate facing away from the array substrate;
a first conductive structure provided within the edge frame area; and
a touch drive integrated circuit located on the array substrate,
wherein the sensing electrode is electrically connected with the touch drive integrated circuit via the first conductive structure.

2. The touch display panel according to claim 1, further comprising a sealant located within the edge frame area and between the array substrate and the opposite substrate and containing therein a conductive gold ball,
wherein the opposite substrate is provided with a first via hole within the edge frame area, the first via hole penetrates the opposite substrate and is filled therein with a first conductor that is electrically connected with a corresponding conductive gold ball in the sealant, and the first conductive structure is comprised of the first conductor and the conductive gold ball.

3. The touch display panel according to claim 2, wherein each sensing electrode corresponds to at least one first via hole.

4. The touch display panel according to claim 2, wherein the first via hole is provided in a portion of the opposite substrate within the edge frame area and corresponding to the sealant, such that the first conductor filled in each first via hole is in direct electrical contact with a corresponding conductive gold ball in the sealant.

5. The touch display panel according to claim 2, wherein the first via hole has a circular cross-section with a diameter smaller than or equal to a width of the corresponding sensing electrode.

6. The touch display panel according to claim 2, further comprising a first signal line arranged on the array substrate, the first signal line being electrically connected with the touch drive integrated circuit and the conductive gold ball that corresponds to the first via hole.

7. The touch display panel according to claim 6, wherein there is a one-to-one correspondence between the first signal line and the sensing electrode.

8. The touch display panel according to claim 1, further comprising a touch electrode arranged on the array substrate, the touch electrode being provided in a one-to-one correspondence with the sensing electrode.

9. The touch display panel according to claim 1, further comprising a touch electrode arranged on the opposite substrate and a second conductive structure provided within the edge frame area, the touch electrode being electrically connected with the touch drive integrated circuit via the second conductive structure.

10. The touch display panel according to claim 2, further comprising a touch electrode arranged on the opposite substrate and a second conductive structure provided within the edge frame area, the touch electrode being electrically connected with the touch drive integrated circuit via the second conductive structure.

11. The touch display panel according to claim 9, wherein the opposite substrate is provided with a second via hole within the edge frame area, the second via hole penetrates the opposite substrate and is filled therein with a second conductor that is electrically connected with a corresponding conductive gold ball in the sealant, and the second conductive structure is comprised of the second conductor and the conductive gold ball corresponding to the second conductor.

12. The touch display panel according to claim 10, wherein the opposite substrate is provided with a second via hole within the edge frame area, the second via hole penetrates the opposite substrate and is filled therein with a second conductor that is electrically connected with a corresponding conductive gold ball in the sealant, and the second conductive structure is comprised of the second conductor and the conductive gold ball corresponding to the second conductor.

13. The touch display panel according to claim 12, wherein each sensing electrode corresponds to at least one second via hole.

14. The touch display panel according to claim 12, wherein the second via hole is provided in a portion of the opposite substrate within the edge frame area and corresponding to the sealant, such that the second conductor filled in each first via hole is in direct electrical contact with the corresponding conductive gold ball in the sealant.

15. The touch display panel according to claim 12, wherein the second via hole has a circular cross-section with a diameter smaller than or equal to a width of the corresponding touch electrode.

16. The touch display panel according to claim 12, further comprising a second signal line arranged on the array substrate, the first signal line being electrically connected with the touch drive integrated circuit and the conductive gold ball that corresponds to the second via hole.

17. The touch display panel according to claim 16, wherein there is a one-to-one correspondence between the second signal line and the touch electrode.

18. A touch display device, comprising the touch display panel according to claim 1.

19. A touch display device, comprising the touch display panel according to claim 2.

20. A touch display device, comprising the touch display panel according to claim 11.
